(19) United States
(12) Patent Application Publication
(10) Pub. No.: US 2017/0257466 A1
(43) Pub. Date: Sep. 7, 2017

(54) SYSTEM AND METHOD FOR ADAPTIVE LEARNING TIME BASED NETWORK TRAFFIC MANAGER

(71) Applicant: FREESCALE SEMICONDUCTOR, INC., Austin, TX (US)

(72) Inventors: Ron Michael Bar, Ramat Hasharon (IL); Eran Glickman, Rishon Le Zion (IL); Amir David Modan, Omer (IL)

(21) Appl. No.: 15/058,993

(22) Filed: Mar. 2, 2016

(51) Int. Cl. H04L 29/06; H04L 12/841; H04L 12/815; H04L 29/08

(52) U.S. Cl. CPC H04L 69/22; H04L 67/30; H04L 47/28; H04L 47/22

(57) ABSTRACT

Data packets are received at a media access control interface. An arbitration policy at a traffic management controller adapts to changes in network traffic characteristics by implementing a learning phase during which processing time information based upon individual packets is updated. The processing time information includes first processing time information for processing data packets associated with a first packet profile of a plurality of packet profiles. A first data packet is selected for processing from amongst a plurality of available data packets having different packet profiles based on the first processing time information.

### FIELD OF THE DISCLOSURE

This disclosure generally relates to network traffic management, and more particularly relates to a system and method for selectively forwarding network data traffic to a traffic processor based on packet profiles and processing time information corresponding to each profile.

### BACKGROUND

A data processing system may utilize a network traffic manager to facilitate reception and processing of incoming data packets. Incoming data packets can be stored in memory where they wait for the traffic manager to select a specific packet for processing. The selection process can be performed based on a first-in/first-out basis, or a round-robin protocol when multiple packets arrive at the same time. Network traffic processing can include traffic classification, marking, policing, discarding, routing, and can include additional operations known in the art. Packet processing can include parsing and manipulation of a packet header, and can further include inspection of a packet payload. One measure of performance of a data processing system can include how efficiently the system processes incoming network traffic. For example, a quality of service metric can indicate how efficiently the data processing system manages network data transactions.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating portions of a data processing device 100 according to a specific embodiment of the present disclosure;

FIG. 2 is a block diagram illustrating further features of the traffic manager of FIG. 1 according to a specific embodiment of the present disclosure;

FIG. 3 is a flow diagram illustrating a method for managing network traffic according to a specific embodiment of the present disclosure;

FIG. 4 is a flowchart illustrating a method for managing network traffic according to another embodiment of the present disclosure;

FIG. 5 is a flow diagram illustrating a method for managing network traffic according to still another embodiment of the present disclosure;

FIG. 6 is a flow diagram illustrating a method for managing network traffic according to another embodiment of the present disclosure; and

FIG. 7 is a flow diagram illustrating a method for managing network traffic according to still another embodiment of the present disclosure;

The use of the same reference symbols in different drawings indicates similar or identical items.

### DETAILED DESCRIPTION OF DRAWINGS

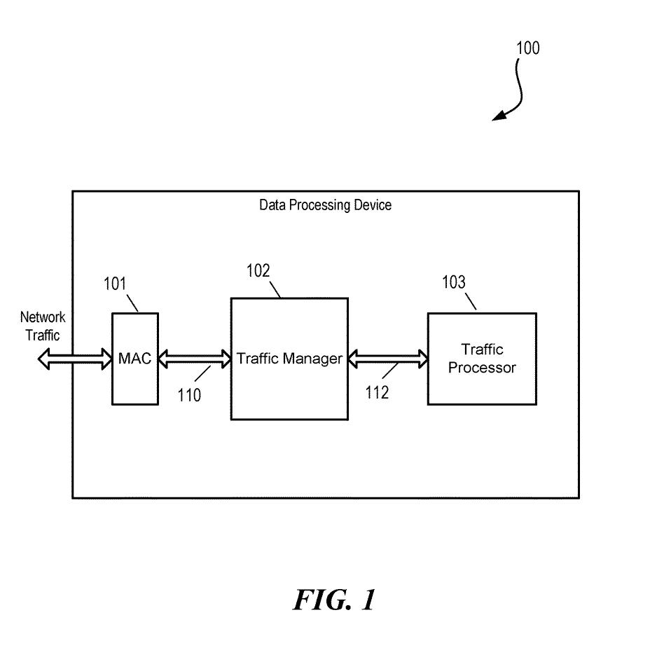

FIGS. 1-7 illustrate network traffic management techniques, also referred to as traffic control, for selectively forwarding network data traffic to a traffic processor. Each incoming data packet is associated with a particular packet profile. For example, packets that are compliant with Internet Protocol version 4 (IPv4) may be associated with one profile, and packets compliant with Internet Protocol version 6 (IPv6) may be associated with another profile. During a learning phase, a network traffic manager is configured to determine processing time information associated with packets corresponding to each profile. For example, processing time information can include an average time to process packets of each profile. Actual data packets are used to determine the processing time information so that the measurements are indicative of real network traffic. Following the learning phase, the network traffic manager can arbitrate between multiple incoming packets to determine an order in which packets are forwarded to the traffic processor. In an embodiment, the network traffic manager can perform the arbitration based on the profile of each packet that is waiting for processing, and the processing time information determined during the learning phase. For example, the network traffic manager can determine that an average time to process an IPv4 frame is ten cycles, while the average time to process an IPv6 frame is one hundred cycles. The network traffic manager may be configured to favor processing of IPv4 frames relative to IPv6 frames to improve an overall packet processing throughput. For simplicity, the following discussion refers to average processing time, however one of skill will appreciate that processing time information can include a mean, a median, or another measure of processing duration corresponding to each packet profile.

Data packets can be differentiated into particular profiles based on one or more considerations, and these considerations can be programmable, allowing for dynamic configurability. For example, packets can be segregated based on information that is parsed from a packet header included at each data packet. The network traffic manager can refine arbitration rules based on recent network traffic characteristics. Arbitration rules and other selection criteria can be configured under program control, and these can be refined autonomously based on current traffic composition. Techniques disclosed herein can be used to improve network traffic throughput, reduce congestion and latency, minimize packet loss, avoid starvation, maintain specified quality of service characteristics and threshold monitored average, and the like.

FIG. 1 illustrates portions of a data processing device 100 according to a specific embodiment of the present disclosure. Data processing device 100 includes a media access control interface (MAC) 101, a network traffic manager 102, and a traffic processor 103. MAC 101 includes an interface to receive network data, for example from devices external to data processing device 100. Network data is transmitted using data packets. A data packet includes a header portion containing packet information, and a payload portion containing the actual data that is being communicated. MAC 101 is coupled to ports of traffic manager 102 by an interconnect 110, over which MAC 101 can forward information identifying the network data to traffic manager 102 and traffic manager 102 can return acknowledgement indicators to MAC 101. Traffic manager 102 is coupled to traffic processor 103 by an interconnect 112 over which traffic manager 102 can request traffic processor 103 to process a selected data packet, and over which traffic processor 103 can return acknowledgement information to traffic manager 102 after processing of the selected packet is complete.

During operation, MAC 101 can receive network traffic from one or more client devices. Incoming data packets can be stored at a memory device (not shown) where the packet can be held until each data packet is selected for processing by traffic manager 102. MAC 101 forwards information identifying each data packet received at MAC 101 to traffic manager 102 via interconnect 110. The data packet information sent to traffic manager 102 can include some or all of the packet header information. While the data packet information may include some or all of the packet payload, the packet's payload is typically not included. In the following description, classification and arbitration of data packets refers to operations relating to complete packets, but is typically performed based on data packet information that includes only a portion of the packet's contents. For clarity, the data packet information processed by traffic manager 102 is simply referred to as a packet.

The various interconnects disclosed herein are used to communicate information between various modules either directly or indirectly. For example, an interconnect can be implemented as a passive device, such as one or more conductive traces, that transmits information directly between various modules, or as an active device, whereby information being transmitted is buffered, e.g., stored and retrieved, in the processes of being communicated between devices, such as at a first-in first-out memory or other memory device. In addition, a label associated with a interconnect can be used herein to refer to a signal and information transmitted by the interconnect.

Classification of a packet into a particular packet profile can be based on any desired packet attribute, and the classification criteria are configurable. The classification can be performed at MAC 101, traffic manager 102, or may be performed by both MAC 101 and traffic manager 102. For example, data processing device 100 can programmatically configure MAC 101 and/or traffic manager 102 to provide classification of incoming data packets based on attributes parsed from each packet's header. In one embodiment, MAC 101 can classify incoming data packets, and deliver each packet to a particular inbound port of traffic manager 102 that corresponds to the classified packet profile. The classification of data packets into one of a plurality of packet profiles by MAC 101 or traffic manager 102 should not be mistaken with further classification that may be provided at traffic processor 103.

Traffic manager 102 can support two modes of operation. The first mode of operation is a learning phase, and the second mode of operation may be referred to as an arbitration phase, or normal operating phase. During the learning phase traffic manager 102 utilizes a timer to monitor how long it takes traffic processor 103 to process each packet. During the learning phase, traffic manager 102 can select the processing order of processing incoming packets based on particular selection criteria that does not include a processing time element, such as a round-robin, first-in/first-out, or other selection criteria. The packets analyzed during the learning phase are actual network traffic packets, e.g., not synthetic training packets. Traffic manager 102 can associate each packet with one of a predetermined set of packet profiles. The selected packet is forwarded to traffic processor 103 and the processing time for that packet is recorded along with the identity of the particular profile to which the packet is associated. This process is repeated for multiple packets of various profiles. At the end of the learning phase, traffic manager 102 can calculate an average processing time for packets belonging to each profile, and store this information in a data storage device.

In an embodiment, processing time information corresponding to a packet profile can be acquired or updated while traffic manager 102 continues to provide arbitration based on current processing time information. For example, classification criteria can be updated, identifying a new packet profile. Traffic manager 102 can initiate a learning phase for packets corresponding to the new packet profile, where processing time information, such as an average processing time, can be measured. While the updated timing information corresponding to new packet profile is being generated, traffic manger 102 can continue to provide arbitration using previously existing processing time information.

After the learning phase has completed, traffic manager 102 can begin operating in the arbitration phase. During the arbitration phase, traffic manager 102 is configured to provide arbitration of incoming packets. Arbitration includes sequentially selecting one packet to forward to traffic processor 103, from amongst multiple available incoming packets. During the arbitration phase, an incoming packet is selected for processing based on the profile of each packet that is waiting for processing and based on the processing time information determined during the learning phase.

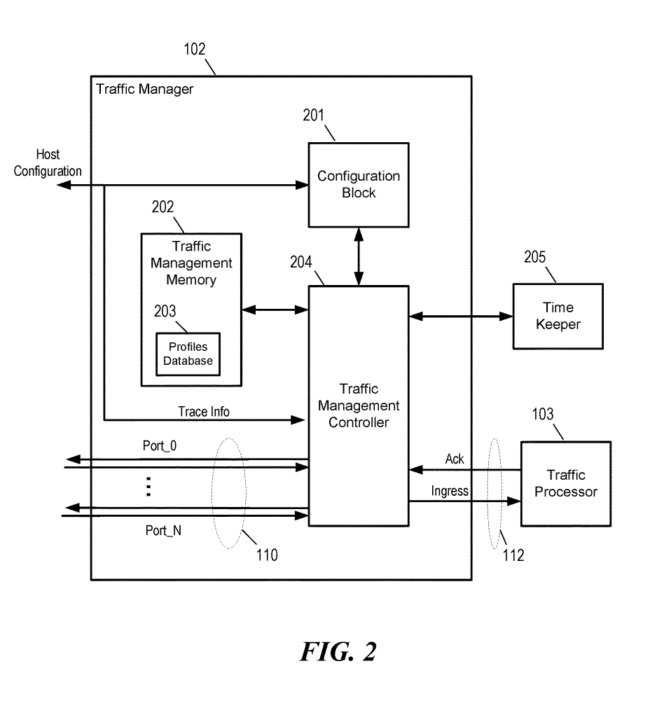

In one embodiment, traffic manager 102 can be responsible for classifying packets received from MAC 101, thereby associating each packet with one of a set of predetermined packet profiles. As described above with reference to MAC 101, the classification can be based on parsing the header of each packet, the port at which the packet is received, or a combination of attributes. Classification criteria used for discriminating to which profile a packet belongs can be programmable and the classification criteria can be refined over time. In a particular embodiment, traffic manager 102 can autonomously refine the classification criteria and/or an arbitration algorithm used to select packets for processing. For example, classification and arbitration refinement can be performed in response to a change in the composition of received network traffic, updated average-processing times collected during a first or subsequent learning phase, or in response to updated configuration information. Operation of traffic manager is described in detail below with reference to FIG. 2.

Traffic processor 103 is configured to parse, classify, and mark packets, to provide policing, shaping, dropping, and routing of packets, and may perform other known or proprietary operations. Similar to classification of packets performed by MAC 101 and/or traffic manager 102, classification of packets by traffic processor 103 can be based information parsed from the packet's header, and can based on information identified in response to deep packet inspection wherein the actual payload of the packet is inspected. Marking refers to modifying network attributes for a specific class of traffic, for example to allow class-based quality of service (QoS) features to recognize traffic classes based on the marking. Traffic policing is the process of monitoring network traffic for compliance with a traffic contract and taking steps to enforce the contract. Traffic shaping is a traffic management technique which delays some or all packets to bring them into compliance with a desired traffic profile. A traffic processor, such as traffic processor 103 can have the discretion to drop packets, wherein a packet is not routed forward to a destination.

FIG. 2 is a block diagram illustrating further features of traffic manager 102 of FIG. 1 according to a specific embodiment of the present disclosure. FIG. 2 also includes traffic processor 103 and a time keeper 205. Traffic manager 102 includes a configuration block 201, a traffic management memory 202, and a traffic management controller 204. Traffic management memory 202 is configured to store a profiles database 203. Configuration block 201 includes a host interface to support communication with other components of data processing device 100, and another interface for communicating with traffic management controller 204. Traffic management controller 204 is coupled to MAC 101 via interconnect 110 and with traffic processor 103 via interconnect 112, as shown in FIG. 1, and to the host. Traffic management controller 204 is also coupled to traffic management memory 202 and to time keeper 205.

In an embodiment, traffic management controller 204 can include a plurality of input ports, each port corresponding to a portion of interconnect 110, illustrated as individual data channels labeled Port_0 to Port_N at FIG. 2. MAC 101 can include selection logic to select on which port, of Ports 0 to N, to associate each incoming data packet. In one embodiment, each port of interconnect 110 can correspond to a particular packet profile. For example, classification logic at MAC 101 can parse a packet header associated with each incoming data packet and selectively route the packet to particular input port of traffic manager 102 based on information included in the packet header. For example, information included in a packet header can be used to associate IPv4 packets with one packet profile, IPv6 packets with another packet profile, and multi-protocol label switching (MPLS) packets with still another packet profile. In an alternate embodiment, MAC 101 can communicate received packets without associating each received data packet with a particular packet profile. In still another embodiment, MAC 101 can classify incoming data packets based on one set of criteria and traffic manager 102 can provide additional classification based on a second set of criteria.

The host interface coupled to configuration block 201 and to traffic management controller 204 allows data processing device 100 to configure operation of traffic manager 102 and to receive status information from traffic manager 102. For example, data processing device 100 can provide updated profile classification and arbitration criteria to traffic manager 102 by storing information at data registers (not shown) included at configuration block 201. In addition, data processing device 100 can retrieve information stored at the registers of configuration block 201. For example, configuration block 201 can maintain a record of network traffic processed by traffic manager 102; including packet processing productivity, arbitration records, debug and other trace information, and the like. In an embodiment, data processing device 100 can initiate the learning phase of operation of traffic manager 102 via the host interface, and may direct acquisition of processing data during the learning phase. In another embodiment, traffic manager 102, and traffic management controller 204 in particular, can be responsible for conducting all or some aspects of the learning phase based on configuration parameters stored at configuration block 201. The host interface and/or configuration block 201 can be coupled to MAC 101 (not shown at FIG. 2) to provide MAC 101 with configuration information, such as packet profile classification criteria.

During the learning phase, traffic management controller 204 can select an incoming packet received from MAC 101, and forward the packet to traffic processor 103 for processing, referred to herein and depicted at FIG. 2 as signal Ingress. Time keeper 205 is signaled at the beginning of processing. The selected packet includes a packet ID. When processing of the selected packet has completed, traffic processor returns an acknowledgment, depicted at FIG. 2 as signal Ack, to traffic management controller 204. The acknowledgement can include the packet ID, and optionally other packet processing information, such as packet type or other profile information. In response to receiving the acknowledgment, time keeper 205 is again notified, which in turn provides traffic management controller 204 with an indication of the duration of the packet processing operation. The processing duration can be represented as a count of clock cycles of a clock signal associated with traffic processor 103 or another unit of measure representing time. For example, time keeper 205 can include a counter that is incremented on each clock transition from ingress of a packet to traffic processor 103 until an acknowledgment indicating processing has completed.

Traffic management controller 204 can store a record of the packet profile and the processing duration. Additional packets can be forwarded for processing and the processing times and profile types can be collected and stored at traffic management memory 202. When a predetermined number of packets of each profile type have been processed, and corresponding processing times have been collected, traffic management controller 204 or another module of data processing device 100 can compute an average processing time for packets associated with each profile. The average processing time for each packet profile can be stored at profiles database 203.

Following completion of the learning phase, traffic management controller 204 is responsible for determining an order in which packets received from MAC 101 are sent to traffic processor 103 for processing. In addition to the information acquired during the learning phase, an arbitration process for selecting packets for processing can evaluate other criteria, including information provided by configuration block 201. For example, traffic management controller 204 can favor selection of packets based on a weighting factor associated with a particular input port, information parsed from each packet header, and the like. Arbitration criteria can change dynamically, either based on analysis performed by traffic management controller 204 or based on a change in configuration at configuration block 201. For example, in order to maintain a prerequisite quality of service metric, particular packets may be favored for processing based on the client or device associated with that packet, on which port the packet was received, and the like. Arbitration can be based on packet profiles having a longest average processing time, packet profiles having a shortest average processing time, other criteria, and a combination of factors. For example, traffic management controller 204 can be configured to give precedence to packets associated with profiles having shorter average processing times.

In an embodiment, traffic management controller 204 can be configured to trace network activity, record arbitration decisions, perform debugging procedures, and to store other operational status information. All, or a portion, of this information can be made available to data processing device 100 via the host configuration interface. In a particular embodiment, configuration block 201 can include a bandwidth limiter (not shown) to manage network traffic flow control and to satisfy quality of service requirements. Bandwidth limiting can be administered on the basis of packet profile, port number, information included in a packet header, and the like. Bandwidth limiting criteria can be provided to configuration block 201 via the host interface. Bandwidth limiting can be utilized to prevent upstream buffers, such as first-in first-out (FIFO) buffers from exceeding threshold capacity limits. For example, traffic management controller can refuse to acknowledge reception of some packets received from MAC 101 in order to maintain a requisite bandwidth requirements mandated by configuration block 201.

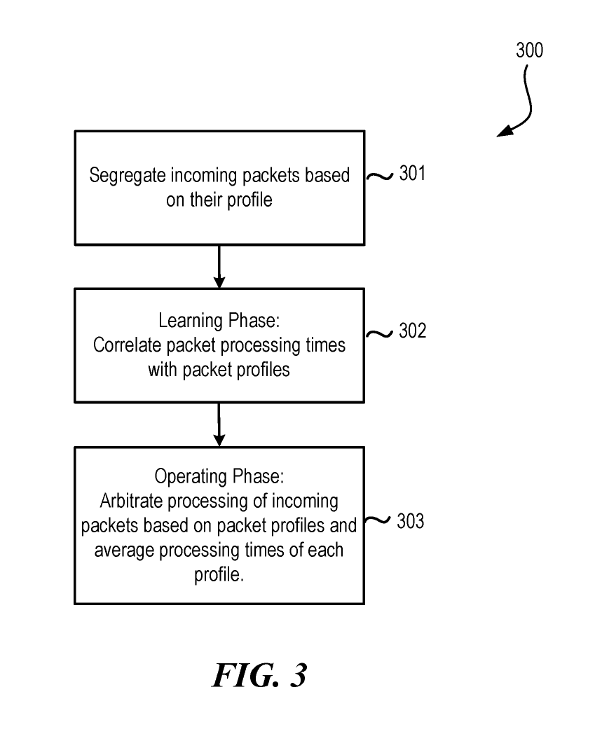

FIG. 3 illustrates a method 300 for managing network traffic according to a specific embodiment of the present disclosure. Method 300 begins at block 301 where a network traffic manager initiates a learning phase. The learning phase is a mode of operation where a network traffic manager correlates packet processing times with each of a preselected set of packet profiles. For example, traffic manager 102 can classify each incoming data packet with a particular packet profile. In one embodiment, the classification criteria can uniquely distinguish each packet as corresponding to only one profile of the set of profiles. In an alternate embodiment, the classification criteria can cause a packet to be associated with more than one profile. Traffic manager 102 can measure the time required for a packet processor to parse, classify, police, and route a packet, and associate the measured time with packets having the same packet profile. After processing multiple packets corresponding to each profile, traffic management controller 204 divides the total time to process those packets of a particular profile by the total number of packets of that profile that were processed, thereby determining an average processing time for packets associated with that specific profile. The average profile processing time information can be stored at profiles database 203.

Method 300 continues at block 302 after completion of the learning phase. During an operating phase, arbitration to select one of an incoming packet for processing is based on the profile of each of the pending packets and average processing time of each profile determined during the learning phase. For example, traffic manager 102 can identify the profile of each data packet received from MAC 101 and select which packet of the pending packets to forward to traffic processor 103 based on an arbitration algorithm that evaluates the profile of pending packets and the average packet processing information stored at profiles database 203. The arbitration algorithm can take into consideration additional factors, including criteria provided by configuration block 201.

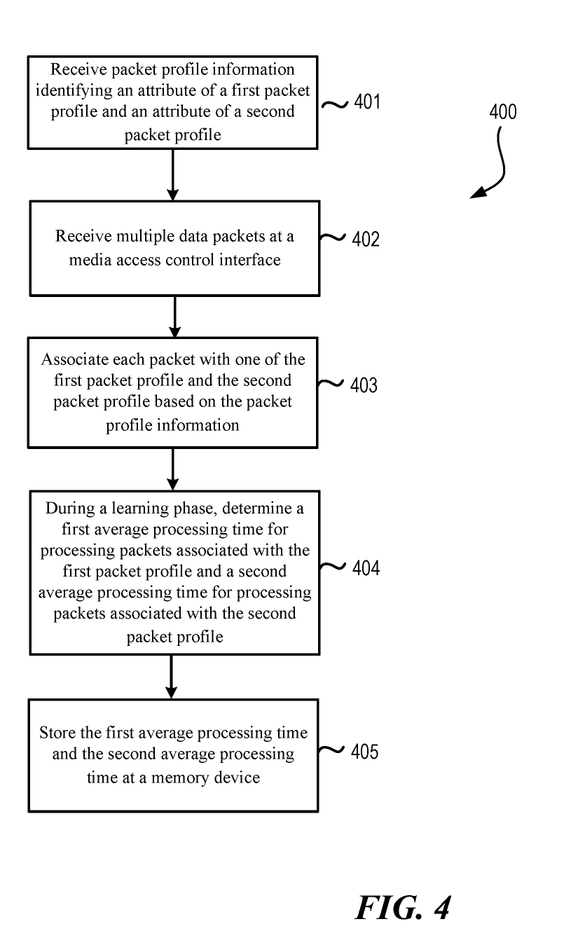

FIG. 4 illustrates a method 400 for managing network traffic according to another embodiment of the present disclosure. Method 400 illustrates operation of traffic manager 102 during the learning phase. Method 400 begins at block 401 where packet profile information is received, the information identifying an attribute of a first packet profile and an attribute of a second packet profile. The profile information includes criteria used to classify incoming packets, thereby segregating the packets into corresponding packet profiles. For example, the profile information can specify that packets having an IPv4 attribute are associated with the first packet profile, while packets having an IPv6 attribute are associated with the second packet profile. The profile information can include any information facilitating segregation of a data packet into a specific one of a set of mutually exclusive packet profiles. The profile information can be receive at traffic manager 102 via the host interface of FIG. 2, and can be stored at configuration block 201. The method continues at block 402 where multiple data packets are received at a media access control interface. At block 403, each of the packets received at block 402 are associated with one of either the first packet profile or the second packet profile based on the packet profile information received at block 401.

Method 400 continues at block 404 where, during a learning phase, a first average processing time for processing packets associated with the first packet profile is determined, and a second average processing time for processing packets associated with the second packet profile is determined. For example, traffic management controller 204 can use time keeper 205 to measure the time from ingress of a packet to traffic processor 103 and receipt of an acknowledgement from traffic processor 103 indicating processing has completed. An average processing time for packets belonging to each profile can be determined based on processing of a predetermined number of packets corresponding to each profile. Method 400 completes at block 405 where the first average processing time and the second average processing time are stored at a memory device. Following the learning phase, incoming data packets can be selected for processing based on a packet profile of each incoming data packet, the first average processing time, and the second average processing time.

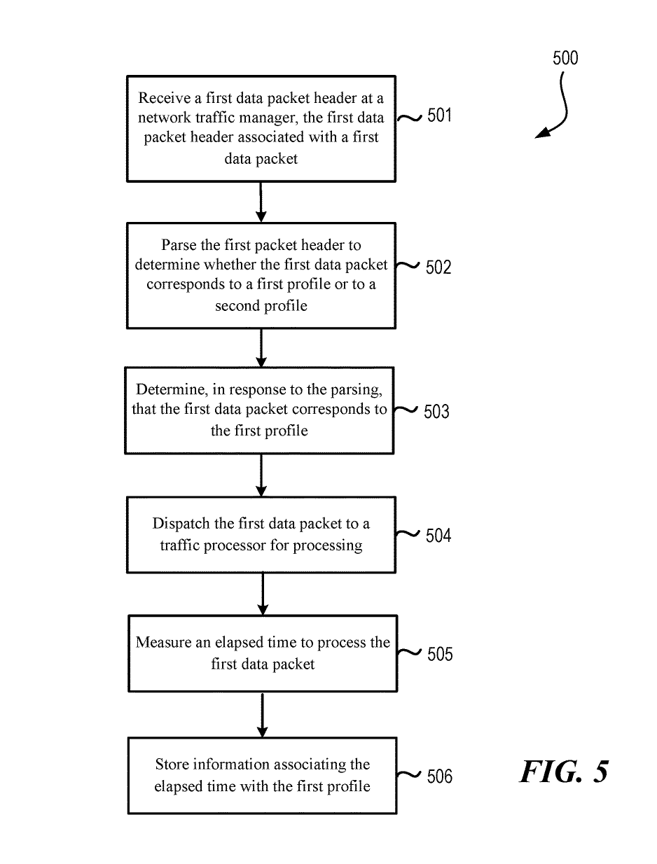

FIG. 5 illustrates a method 500 for managing network traffic according to still another embodiment of the present disclosure. Method 500 illustrates measuring the processing time of a data packet at traffic manager 102 during the learning phase. Method 500 begins at block 501 where a first data packet header is received at a network traffic manager, the first data packet header associated with a first data packet. The method continues at block 502 where the first packet header is parsed to determine whether the first data packet corresponds to a first packet profile or to a second packet profile. Method 500 proceeds to block 503 where, in response to the parsing, it is determined that the packet corresponds to the first packet profile. At block 504, the first packet is dispatched to a traffic processor for processing. At block 505, the network traffic manager measures an elapsed time to process the first data packet. Method 500 completes at block 506 where information associating the elapsed time with the first profile is stored. The steps of method 500 can be repeated for multiple packets, and an average processing time can be computed for packets associated with each profile. While method 500 illustrates a first and a second profile, one of skill will appreciate that the packets can be segregated into additional profiles, and an average processing time can be determined for each packet profile.

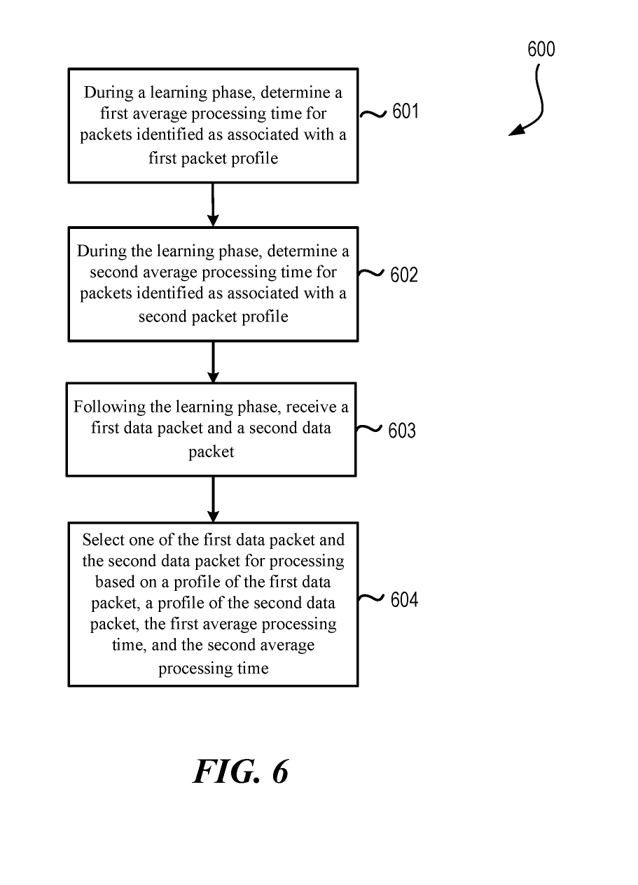

FIG. 6 illustrates a method 600 for managing network traffic according to another embodiment of the present disclosure. Method 600 illustrates operation of traffic manger 102 during the learning phase and during the arbitration phase. Method 600 begins at block 601 where a first average processing time is determined for packets identified as associated with a first packet profile. The method continues at block 602 where a second average processing time is determined for packets identified as associated with a second packet profile. At block 603, a first data packet and a second data packet are received. Method 600 concludes at block 604 where one of the first data packet and the second data packet is selected for processing based on a profile of the first data packet, a profile of the second data packet, the first average processing time, and the second average processing time.

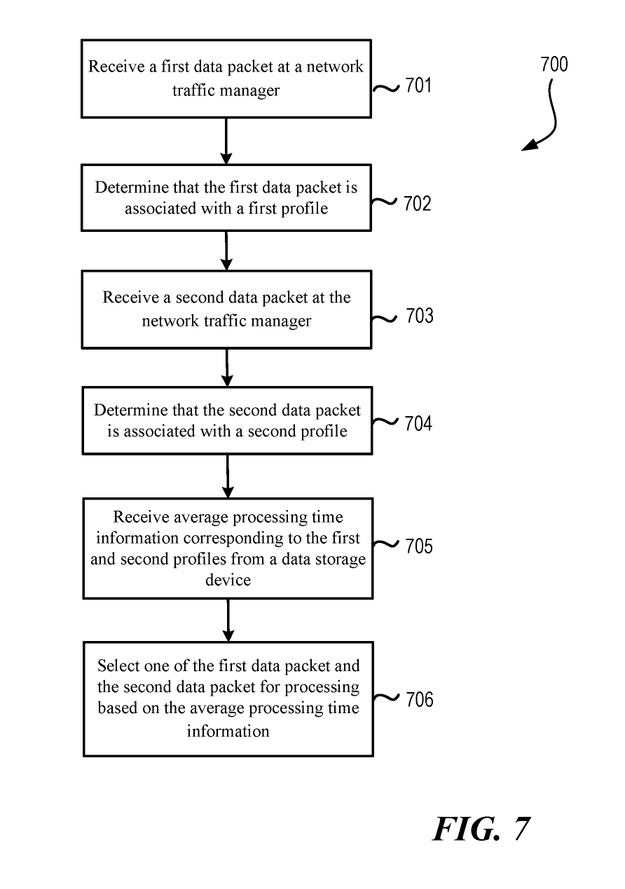

FIG. 7 illustrates a method 700 for managing network traffic according to yet another embodiment of the present disclosure. Method 700 illustrates operation of traffic manger 102 during the arbitration phase. Method 700 begins at block 701 where a first data packet is received at a network traffic manager. At block 702, it is determined that first data packet is associated with a first profile. At block 703 a second data packet is received at the network traffic manager, and at block 704, it is determined that second data packet is associated with a second profile. At block 705, average processing time information corresponding to the first and second profiles is received from a data storage device. Method 700 completes at block 706 where one of the first data packet and the second data packet is selected based on the average processing time information. As described above, the average processing time information is determined during a learning phase.

Embodiments incorporating teachings of the present disclosure are shown and described with respect to the drawings presented herein. In a first aspect, a network traffic management system includes a media access controller configured to receive data packets; a traffic processor configured to process the data packets; a traffic management controller coupled to the media access controller and the traffic processor, and an arbiter. The traffic management controller is configured to adapt an arbitration policy to changes in network traffic characteristics by implementing a learning phase during which processing time information based upon individual packets is updated, the processing time information including first processing time information for processing data packets associated with a first packet profile of a plurality of packet profiles. The arbiter is configured to select for processing a first data packet from amongst a plurality of available data packets having different packet profiles based on the first processing time information.

In an embodiment of the first aspect, the processing time information further includes second processing time information for processing packets associated with a second packet profile of the plurality of packet profiles, and the arbiter is further configured to select the first data packet based upon the second processing time information. In another embodiment of the first aspect, the selecting for processing is further based on arbitration rules, the arbitration rules being configurable. In another embodiment of the first aspect, the media access controller is configured to associate each data packet of a plurality of incoming data packets with one of the plurality of packet profiles; and provide the associated packet to a port of the traffic management controller corresponding to the associated packet profile. In still another embodiment of the first aspect, the traffic management controller is further configured to associate a first data packet with the first packet profile in response to determining that the first data packet is received at a first port of the traffic management controller; and associate a second data packet with the second packet profile in response to determining that the second data packet is received at a second port of the traffic management controller.

In yet another embodiment of the first aspect, the traffic management controller is further configured to receive packet profile information identifying an attribute of each of the plurality of packet profiles, including an attribute of the first packet profile and an attribute of the second packet profile; and associate each incoming data packet with one of the first packet profile and the second packet profile based on the packet profile information. In another embodiment of the first aspect, the traffic management controller is further configured to parse a header of a first data packet; determine, in response to the parsing, that the header includes the attribute of the first packet profile; and associate the first data packet with the first packet profile based on the determining. In a particular embodiment of the first aspect, the attribute of the first packet profile is an Internet Protocol version.

In another embodiment of the first aspect, the time keeper is further configured to initiate a measurement of an elapsed time in response to the traffic management controller forwarding a first data packet to the traffic processor; and terminate the measuring of the elapsed time in response to receiving an acknowledgement from the traffic processor that processing of the first data packet is complete.

In a second aspect, a method includes receiving a plurality of data packets at a media access control interface; and adapting an arbitration policy at a traffic management controller to changes in network traffic characteristics by implementing a learning phase during which processing time information based upon individual packets is updated, the processing time information including first processing time information for processing data packets associated with a first packet profile of a plurality of packet profiles; and selecting for processing a first data packet from amongst a plurality of available data packets having different packet profiles based on the first processing time information.

In an embodiment of the second aspect, the processing time information further includes second processing time information for processing packets associated with a second packet profile of the plurality of packet profiles, and the arbiter is further configured to select the first data packet based upon the second processing time information. In another embodiment of the second aspect, the selecting for processing is further based on arbitration rules, the arbitration rules being configurable. In still an embodiment of the second aspect, the method further includes associating each data packet of the plurality of data packets with one of the plurality of packet profiles, the associating performed at a media access controller. In another embodiment of the second aspect, the method further includes associating a first data packet with the first packet profile in response to determining that the first data packet is received at a first port of a traffic manager; and associating a second data packet with the second packet profile in response to determining that the second data packet is received at a second port of the traffic manager.

In yet another embodiment of the second aspect, the method includes receiving packet profile information identifying an attribute of the first packet profile and an attribute of the second packet profile; and associating each data packet with one of the plurality of packet profiles based on the packet profile information. In a particular embodiment of the second aspect, the associating further includes parsing a header of a first data packet; determining, in response to the parsing, that the header includes the attribute of the first packet profile; and associating the first data packet with the first packet profile based on the determining. In another particular embodiment of the second aspect, the attribute of the first packet profile is an Internet Protocol version. In an embodiment of the second aspect determining the first processing time information includes initiating a measurement of an elapsed time in response to forwarding a first data packet associated with the first packet profile to a traffic processor; and ending the measurement of the elapsed time in response to receiving an acknowledgement from the traffic processor that processing of the first data packet is complete.

In a third aspect, a method includes determining, at a network traffic manager, a first average time for processing packets identified as associated with a first packet profile; determining, at the network traffic manager, a second average time for processing packets identified as associated with a second packet profile; receiving a first data packet and a second data packet at the network traffic manager; and selecting the first data packet for processing based on the first average processing time and the second average processing time. In an embodiment of the third aspect, the selecting for processing is further based on a packet profile of the first data packet and arbitration rules, the arbitration rules being configurable.

It will be appreciated that for simplicity and clarity of illustration, elements illustrated in the Figures have not necessarily been drawn to scale. For example, the dimensions of some of the elements are exaggerated relative to other elements.

It will be appreciated that the devices disclosed herein can be implemented in various manners using various types of memory. In particular, the application of the equalization as described herein, is not limited to applications in the disclosed embodiments, but can be applied in other instances where signal equalization is needed or desired.

The preceding description in combination with the Figures was provided to assist in understanding the teachings disclosed herein. The discussion focused on specific implementations and embodiments of the teachings. This focus was provided to assist in describing the teachings, and should not be interpreted as a limitation on the scope or applicability of the teachings. However, other teachings can certainly be used in this application. The teachings can also be used in other applications, and with several different types of architectures.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

As used herein, the term “bus” is used to refer to a plurality of signals or conductors that may be used to transfer one or more various types of information, such as data, addresses, control, or status. The conductors as discussed herein may be illustrated or described in reference to being a single conductor, a plurality of conductors, unidirectional conductors, or bidirectional conductors. However, different embodiments may vary the implementation of the conductors. For example, separate unidirectional conductors may be used rather than bidirectional conductors and vice versa. Also, plurality of conductors may be replaced with a single conductor that transfers multiple signals serially or in a time multiplexed manner. Likewise, single conductors carrying multiple signals may be separated out into various different conductors carrying subsets of these signals. Therefore, many options exist for transferring signals.

As used herein, the term “machine-executable code” can refer to instructions that can be provided to a processing device and can be executed by an execution unit. The machine-executable code can be provided from a system memory, and can include a system BIOS, firmware, or other programs. In addition, machine-executable code can refer to microcode instructions that can be used by a processing device to execute instructions, and can be provided by a microcode memory of the processing device.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A network traffic management system comprising:
a media access controller configured to receive data packets;
a traffic processor configured to process the data packets;
a traffic management controller coupled to the media access controller and the traffic processor, the traffic management controller configured to adapt an arbitration policy to changes in network traffic characteristics by implementing a learning phase during which processing time information based upon individual packets is updated, the processing time information including first processing time information for processing data packets associated with a first packet profile of a plurality of packet profiles; and
an arbiter configured to select for processing a first data packet from amongst a plurality of available data packets having different packet profiles based on the first processing time information.

2. The system of claim 1, wherein the processing time information further includes second processing time information for processing packets associated with a second packet profile of the plurality of packet profiles, and the arbiter is further configured to select the first data packet based upon the second processing time information.

3. The system of claim 1, wherein the selecting for processing is further based on arbitration rules, the arbitration rules being configurable.

4. The system of claim 1, wherein the media access controller is configured to:
associate each data packet of a plurality of incoming data packets with one of the plurality of packet profiles; and
provide the associated packet to a port of the traffic management controller corresponding to the associated packet profile.

5. The method of claim 4, wherein the traffic management controller is further configured to:
associate a first data packet with the first packet profile in response to determining that the first data packet is received at a first port of the traffic management controller; and
associate a second data packet with the second packet profile in response to determining that the second data packet is received at a second port of the traffic management controller.

6. The system of claim 1, wherein the traffic management controller is further configured to:
receive packet profile information identifying an attribute of each of the plurality of packet profiles, including an attribute of the first packet profile and an attribute of the second packet profile; and
associate each incoming data packet with one of the first packet profile and the second packet profile based on the packet profile information.

7. The system of claim 6, wherein the traffic management controller is further configured to:
parse a header of a first data packet;
determine, in response to the parsing, that the header includes the attribute of the first packet profile; and
associate the first data packet with the first packet profile based on the determining.

8. The system of claim 6, wherein the attribute of the first packet profile is an Internet Protocol version.

9. The system of claim 1, wherein the time keeper is further configured to:
initiate a measurement of an elapsed time in response to the traffic management controller forwarding a first data packet to the traffic processor; and
terminate the measuring of the elapsed time in response to receiving an acknowledgement from the traffic processor that processing of the first data packet is complete.

10. A method comprising:
receiving a plurality of data packets at a media access control interface;
adapting an arbitration policy at a traffic management controller to changes in network traffic characteristics by:
implementing a learning phase during which processing time information based upon individual packets is updated, the processing time information including first processing time information for processing data packets associated with a first packet profile of a plurality of packet profiles; and
selecting for processing a first data packet from amongst a plurality of available data packets having different packet profiles based on the first processing time information.

11. The method of claim 10, wherein the processing time information further includes second processing time information for processing packets associated with a second packet profile of the plurality of packet profiles, and the arbiter is further configured to select the first data packet based upon the second processing time information.

12. The method of claim 10, wherein the selecting for processing is further based on arbitration rules, the arbitration rules being configurable.

13. The method of claim 10, further comprising associating each data packet of the plurality of data packets with one of the plurality of packet profiles, wherein the associating is performed at a media access controller.

14. The method of claim 10, further comprising:
associating a first data packet with the first packet profile in response to determining that the first data packet is received at a first port of a traffic manager; and
associating a second data packet with the second packet profile in response to determining that the second data packet is received at a second port of the traffic manager.

15. The method of claim 10, further comprising:
receiving packet profile information identifying an attribute of the first packet profile and an attribute of the second packet profile; and
associating each data packet with one of the plurality of packet profiles based on the packet profile information.

16. The method of claim 15, wherein the associating further comprises:
parsing a header of a first data packet;
determining, in response to the parsing, that the header includes the attribute of the first packet profile; and
associating the first data packet with the first packet profile based on the determining.

17. The method of claim 15, wherein the attribute of the first packet profile is an Internet Protocol version.

18. The method of claim 10, wherein determining the first processing time information comprises:
initiating a measurement of an elapsed time in response to forwarding a first data packet associated with the first packet profile to a traffic processor; and
ending the measurement of the elapsed time in response to receiving an acknowledgement from the traffic processor that processing of the first data packet is complete.

19. A method comprising:
determining, at a network traffic manager, a first average time for processing packets identified as associated with a first packet profile;
determining, at the network traffic manager, a second average time for processing packets identified as associated with a second packet profile;
receiving a first data packet and a second data packet at the network traffic manager; and
selecting the first data packet for processing based on the first average processing time and the second average processing time.

20. The method of claim 19, wherein the selecting for processing is further based on a packet profile of the first data packet and arbitration rules, the arbitration rules being configurable.
